(19) United States
(12) Patent Application Publication
(10) Pub. No.: US 2026/0206739 A1
(43) Pub. Date: Jul. 23, 2026

(54) DEER ATTRACTION APPARATUS

(71) Applicant: Plastic Research and Development Corporation d/b/a PRADCO, Birmingham, AL (US)

(72) Inventors: Jake Nelson, Birmingham, AL (US); Brian Malone, Sterrett, AL (US); Matt Wade, McCalla, AL (US)

(21) Appl. No.: 19/034,545

(22) Filed: Jan. 22, 2025

(51) Int. Cl. A01M 31/00; E02D 5/80; F16M 13/02

(52) U.S. Cl. CPC A01M 31/00; E02D 5/801; F16M 13/02

(57) ABSTRACT

A deer attraction apparatus is disclosed herein. The deer attraction apparatus can be used for securing a tree branch to a structure so a deer can lick or scrape the branch. The deer attraction apparatus includes a base piece and a branch holder extending from the base piece. The branch holder is adjustable to change the angle of the branch holder via a screw and wingnut affixing the branch holder to the base piece. The tree branch can be secured within the branch holder with thumb screws for adjusting based on the size of the tree branch. Attachments to the base allow the deer attraction apparatus to be secured to a structure, such as a tree or a post with a strap or screws, or an auger screwed into the ground.

### TECHNICAL FIELD

The present disclosure generally relates to hunting, and more particularly to deer attraction apparatuses for securing branches to a structure that deer can lick or scrape.

### BACKGROUND

The present disclosure generally relates to hunting, and more particularly to deer hunting. When deer hunting, attracting deer to a location where a hunter is waiting can be a challenge. For instance, deer can detect the presence of hunters, so hunters need a method to conceal their scent or attract deer to the area despite the presence of hunters. Current methods of concealing a hunter’s sent or attracting deer to an area involve complicated methods of using baits and artificial scents in an area to try to attract deer, however these methods are time consuming, costly, and may violate local laws and regulations. What is needed is an improved method for attracting deer to an area.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure generally relates to hunting, and more particularly to deer attraction apparatuses for securing branches to a structure that deer can lick or scrape. When deer hunting, attracting deer to a location where a hunter is waiting can be a challenge. For instance, deer can detect the presence of hunters, so hunters need a method to conceal their scent or attract deer to the area despite the presence of hunters. Deer lick branches to communicate with each other. Bucks may create scrapes or rubs on trees, branches, or the ground during the rut to attract does by rubbing the buck scent into the scrape. A buck or doe may also lick a tree branch overhead to attract other deer. If a hunter knows the location of a licked branch, then the hunter knows deer will likely be present at that location. Therefore, an apparatus that the hunter can use to hold a tree branch at an appropriate height and angle for a deer to lick can be beneficial because the hunter knows where the apparatus is located and thus where deer are more likely to be present.

One aspect of the disclosure is a deer attraction apparatus. The deer attraction apparatus may include a base having a rectangular shape with a flat face comprising a support structure comprising a top tab extending outward from the base, a bottom tab extending outward from the base, and a middle tab between the top tab and the bottom tab, the middle tab comprising a screw aperture and a partial cutout, wherein a gap is formed between the base and the partial cutout. The deer attraction apparatus may include a branch holder extending radially outward from the base and affixed to the middle tab, a screw inserted through the screw aperture and through a screw aperture of the branch holder and secured with a nut to adjust an angle of the branch holder, the branch holder comprising an opening at an end opposite from the base and at least one screw inserted at least partially in the branch holder for adjusting and securing an item at least partially inside the branch holder.

Another aspect of the disclosure is a deer attraction apparatus. The deer attraction apparatus may include a base having a rectangular shape with a flat face comprising a centrally located screw aperture through the flat face and a support structure comprising a top tab extending outward from the base, a bottom tab extending outward from the base, and a middle tab between the top tab and the bottom tab, the middle tab comprising a screw aperture. The deer attraction apparatus may include a branch holder extending radially outward from the base and affixed to the middle tab, a screw inserted through the screw aperture and through the branch holder and secured with a nut to adjust an angle of the branch holder, the branch holder comprising an opening at an end opposite from the base and at least one screw inserted in the branch holder for adjusting and securing an item at least partially inside the branch holder. The deer attraction apparatus may include an auger comprising a head inserted through the centrally located screw aperture of the base and a securing device to affix the auger to the base.

Another aspect of the disclosure is a deer attraction apparatus. The deer attraction apparatus may include a base having a rectangular shape with a flat face comprising a support structure comprising a top tab extending outward from the base, a bottom tab extending outward from the base, and a middle tab between the top tab and the bottom tab, the middle tab comprising a screw aperture and a partial cutout, wherein a gap is formed between the base and the partial cutout, the gap configured for an adjustable strap inserted over the flat face of the base and under a portion of the middle tab and around a structure for securing the deer attraction apparatus to the structure. The deer attraction apparatus may include a branch holder extending radially outward from the base and affixed to the middle tab with a screw inserted through the screw aperture and through the branch holder and secured with a nut to adjust an angle of the branch holder, the branch holder comprising an opening at an end opposite from the base and at least one screw inserted in the branch holder for adjusting and securing a tree branch at least partially inside the branch holder.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure.

FIG. 1A is an exploded view of a deer attraction apparatus according to an example embodiment of the present disclosure.

FIG. 1B is a perspective view of a deer attraction apparatus according to an example embodiment of the present disclosure.

FIG. 1C is a side view of a deer attraction apparatus according to an example embodiment of the present disclosure.

FIG. 1D is a front view of a deer attraction apparatus according to an example embodiment of the present disclosure.

FIG. 1E is a side view of a deer attraction apparatus according to an example embodiment of the present disclosure.

FIG. 2A is a perspective view of a deer attraction apparatus according to an example embodiment of the present disclosure.

FIG. 2B is a side view of a deer attraction apparatus according to an example embodiment of the present disclosure.

FIG. 2C is a front view of a deer attraction apparatus according to an example embodiment of the present disclosure.

FIG. 2D is a side view of a deer attraction apparatus according to an example embodiment of the present disclosure.

FIG. 3A is an exploded view of a deer attraction apparatus according to an example embodiment of the present disclosure.

FIG. 3B is a perspective view of a deer attraction apparatus according to an example embodiment of the present disclosure.

FIG. 3C is a side view of a deer attraction apparatus according to an example embodiment of the present disclosure.

FIG. 3D is a front view of a deer attraction apparatus according to an example embodiment of the present disclosure.

FIG. 3E is a side view of a deer attraction apparatus according to an example embodiment of the present disclosure.

FIG. 4A is a top view of a deer attraction apparatus according to an example embodiment of the present disclosure.

FIG. 4B is a bottom view of a deer attraction apparatus according to an example embodiment of the present disclosure.

### DETAILED DESCRIPTION

Reference will now be made in detail to exemplary embodiments of the disclosure, some aspects of which are illustrated in the accompanying drawings.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

Multiple elements of the same or a similar type may be referred to as “Elements 102(1)-(n)” where n may include a number. Referring to one of the elements as “Element 102” refers to any single element of the Elements 102(1)-(n). Additionally, referring to different elements “First Elements 102(1)-(n)” and “Second Elements 104(1)-(n)” does not necessarily mean that there must be the same number of First Elements as Second Elements and is equivalent to “First Elements 102(1)-(n)” and “Second Elements (1)-(m)” where m is a number that may be the same or may be a different number than n.

The present disclosure is directed to deer attraction apparatuses for securing branches to a structure that deer can lick or scrape. When deer hunting, attracting deer to a location where a hunter is waiting can be a challenge because deer can detect the presence of hunters, so hunters need a method to conceal their scent or attract deer to the area despite the presence of hunters. Bucks may create scrapes or rubs on trees, branches, or the ground during the rut to attract does by rubbing the buck scent into the scrape. A buck or doe may also lick a tree branch overhead to communicate with and attract other deer. If a hunter knows the location of a licked branch, then the hunter knows deer will likely be present at that location. A hunter can use the deer attraction apparatus of the present disclosure to hold a tree branch at an appropriate height and angle for a deer to lick so that the hunter knows where a licked branch is located and thus where deer are more likely to be present. The deer attraction apparatus includes a base piece that can be strapped to a tree, screwed into a wooden post, or inserted into the ground. The base piece may be a mounting bracket with a smaller piece extending outward from the mounting bracket for a branch holder to attach to which has an adjustable angle. A hunter can then place a tree branch in the branch holder and use thumb screws to secure the tree branch. Thus, when a deer licks or scrapes the tree branch, the hunter knows where the licked branch is and where deer will be.

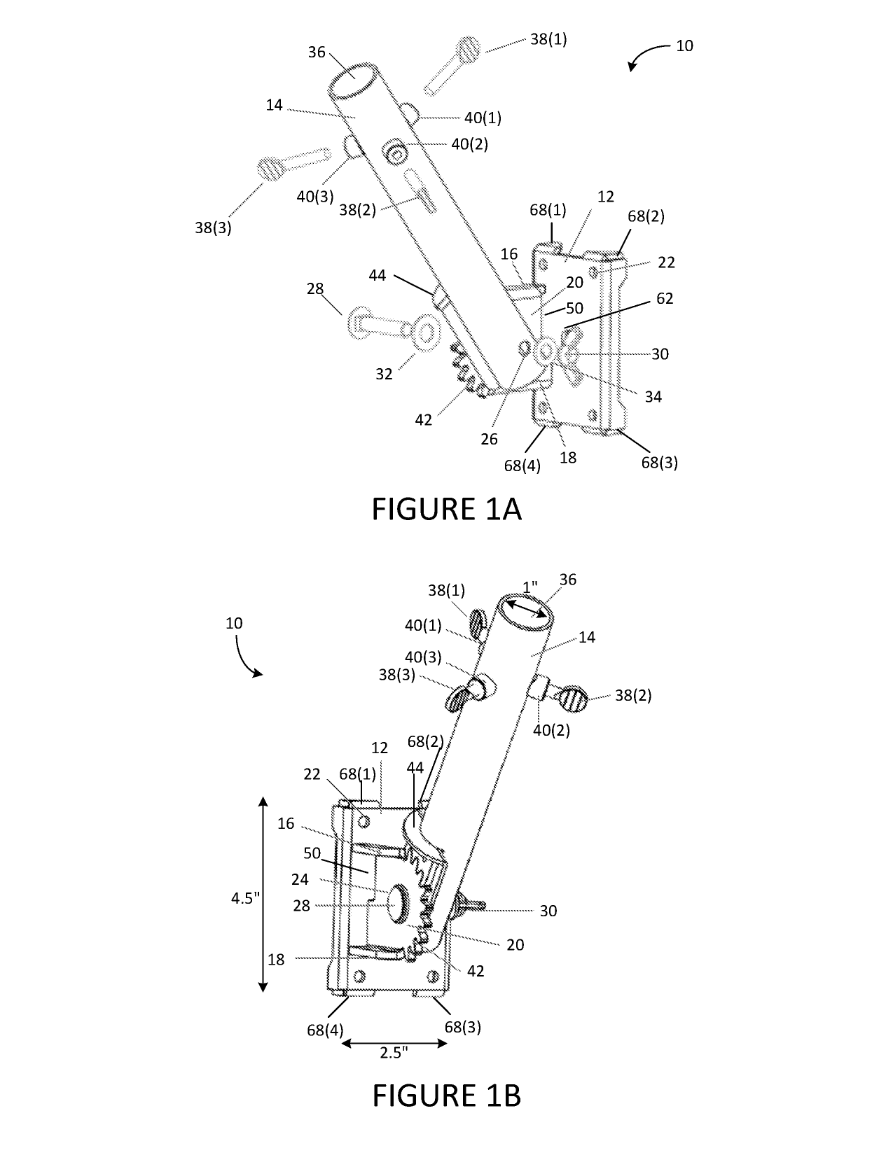

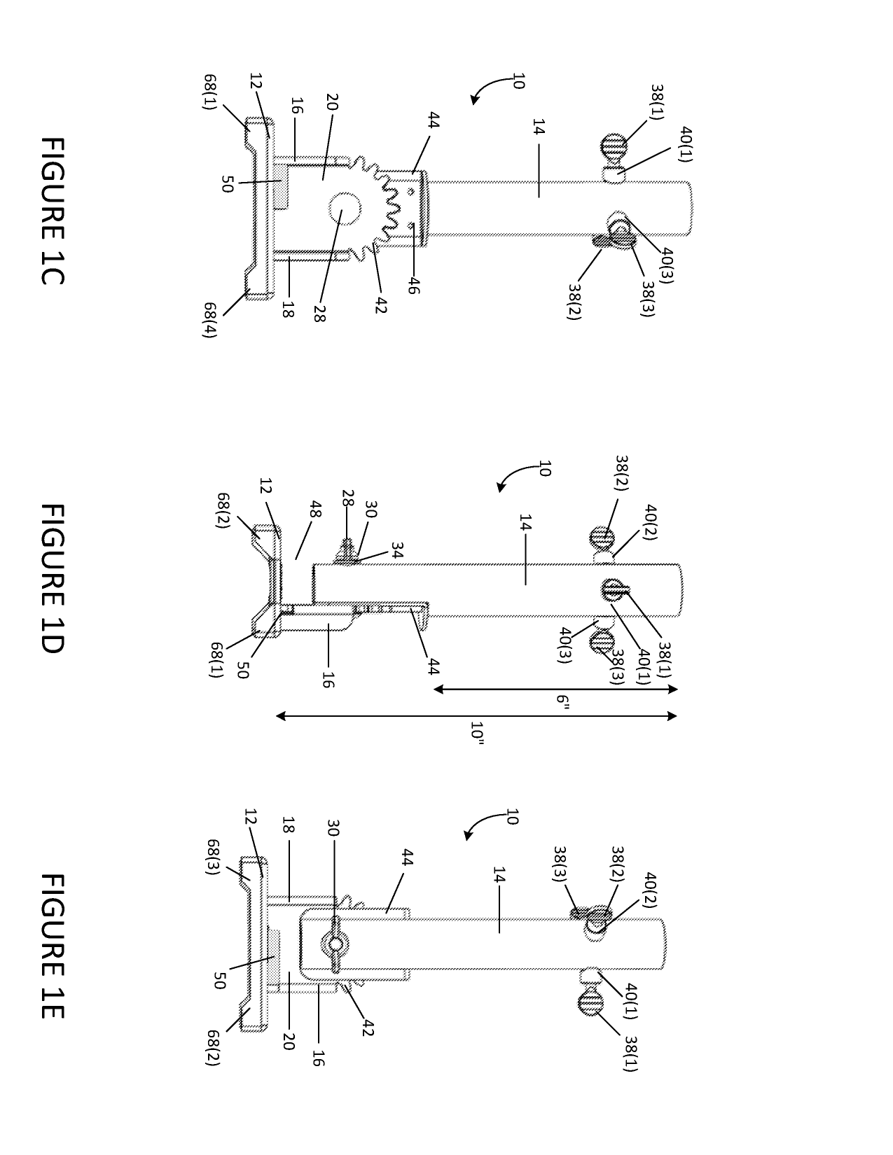

FIG. 1A is an exploded view of a deer attraction apparatus 10 according to an example embodiment of the present disclosure. FIGS. 1B-1E illustrate various perspective views of the deer attraction apparatus 10 according to an example embodiment of the present disclosure. In the examples of FIGS. 1A-1E, the deer attraction apparatus 10 is illustrated as a stand-alone device without being affixed to any structures. The deer attraction apparatus 10 includes a base piece 12 and a branch holder 14 connected to the base 12 by a support structure made of several pieces including a top tab 16, a bottom tab 18, and a middle tab 20 extending from a flat face of the base 12. In some implementations, the base 12 may have one or more screw apertures 22, which may be used to screw the base 12 into a structure, such as a post or tree. For example, there may be four screw apertures each fitted for wood screws as illustrated in FIG. 1A, however there may be more or less screw apertures in some implementations. The base 12 may have a flat face with a rectangular shape or other similar shape for fitting the deer attraction apparatus 10 to a structure. For example, the base 12 may be a rectangle with long edges that are approximately four inches long and short edges that are approximately two and a half inches long. The base 12 may have feet 68 extending from each corner of the bottom of the flat section of the base 12. The feet 68 may be raised from the base to rest against a structure, such as a tree, a post, or the ground, and spaced from each other on the flat underside of the base 12 such that there is space between the underside of the base 12 and the structure. A distance from the bottom of the feet 68 to the top of the branch holder 14 may be approximately ten inches. In other embodiments, the distance from the bottom of the feet 68 to the top of the branch holder 14 may be more or less than ten inches, such as six, eight, twelve, or fourteen inches. In some implementations, the feet 68 may each have an angled piece extending from the bottom of the base 12 to the bottom of each foot to stabilize the deer attraction apparatus 10 on a structure or the ground. The structure of the base 12 of the present disclosure allows for the deer attraction apparatus 10 to be lighter, slimmer, and easier for deer to avoid sensing it. In some examples, the base 12 may be a mounting bracket with apertures for screws or other fixture mechanisms to secure the bracket to a structure and with a flat section from which the tabs extend for attaching the branch holder 14. Additional advantages of the deer attraction apparatus 10 include an all metal construction in some embodiments that allows for a slimmer profile and less visual imprint to a deer, angle adjustments that allow for a variety of branches to be selected and adjusted to the desired height level, several mounting methods in a single apparatus (e.g., screws, a strap, an auger), and the ability to be used in a vertical orientation where the base 12 is parallel to a structure or in a horizontal orientation where the base 12 is parallel to the ground.

The middle tab 20 may have a semi-circle holder 44 for wrapping around the bottom portion of the branch holder 14 and securing the branch holder 14 to the base 12. The holder 44 may have a shape similar to the shape of the branch holder 14 so that the holder 44 can fit flush to the branch holder 14. As illustrated in FIG. 1C, the holder 44 can have one or more screw apertures 46 for securing the holder 44 to the branch holder 14 and/or the middle tab 20 with corresponding screws or other fixture devices. The middle tab 20 may have a screw aperture 24 (illustrated in FIG. 1B) and the branch holder 14 may have a screw aperture 26 for inserting a screw 28 from the side of the middle tab 20 through the screw aperture 24 and the screw aperture 26 that is secured with a nut 30 (e.g., a wingnut) on the side of the branch holder 14. In embodiments with the holder 44 around the branch holder 14, the screw 28 can also go through an aperture in the holder 44, with the holder 44 placed between the middle tab 20 and the branch holder 14. A distance from the top of the holder 44 to the top of the branch holder 14 may be approximately six inches. In other embodiments, the distance from the top of the holder 44 to the top of the branch holder 14 may be more or less than six inches, such as four inches, eight inches, or ten inches. Thus, the branch holder 14 extends radially outward from the base 12 and is affixed to the middle tab 20 in a manner that allows the angle of the branch holder 14 to be adjusted, such as by loosening the nut 30, changing the angle of the branch holder 14, and tightening the nut 30. The angle of the branch holder 14 may be adjusted to an angle between 30 degrees and 150 degrees relative to the base 12. In some embodiments, the angle of the branch holder 14 may be adjusted to an angle between 40 degrees and 140 degrees relative to the base 12. In some embodiments, the angle of the branch holder 14 may be adjusted to an angle between 45 degrees and 135 degrees relative to the base 12. In some embodiments, the angle of the branch holder 14 may be adjusted to an angle between 50 degrees and 130 degrees relative to the base 12. In some embodiments, the angle of the branch holder 14 may be adjusted to an angle between 60 degrees and 120 degrees relative to the base 12. In some embodiments, the angle of the branch holder 14 may be adjusted to an angle between 70 degrees and 110 degrees relative to the base 12. In some embodiments, the angle of the branch holder 14 may be adjusted to an angle between 80 degrees and 100 degrees relative to the base 12.

As illustrated in FIG. 1D, there may be a space 48 between the flat portion of the base 12 and the bottom of the branch holder 14 to allow the branch holder 14 angle to be adjusted and to provide a space for a strap that can be used to secure the deer attraction apparatus 10 to a post or tree. The middle tab 20 may have teeth 42 along a semi-circle shaped exterior of the middle tab 20 which can also be used to aid in adjusting the branch holder 14 by providing a better grip to get the precisely desired angle. In some embodiments, there may be a washer 32 on the side of the middle tab 20 inserted between the screw 28 and the middle tab 20 and/or a washer 34 on the side of the branch holder 14 inserted between the branch holder 14 and the nut 30.

The branch holder 14 can have an opening 36 at the top end, which is opposite from the base 12, such that an item (e.g., a tree branch, a rope, a dripper, a dripper affixed to the item) can be inserted at least partially into the opening 36. The opening 36 may be approximately one inch in diameter to accommodate the diameter of the item. To secure the item in the branch holder 14, there may be at least one screw 38 (e.g., thumb screws as illustrated or another type of adjustable screw) inserted at least partially in the branch holder 14 through raised screw apertures 40. The thumb screws 38 allow items of various sizes to be secured within the branch holder 14. For example, a thin tree branch can be inserted into the opening 36 of the branch holder 14 and the thumb screws 38 can be inserted further into the branch holder 14, while a thicker tree branch can be inserted into the opening 36 of the branch holder 14 and the thumb screws 38 can be inserted less and only partially into the branch holder 14. The thumb screws 38 also allow the item inserted in the opening 36 of the branch holder 14 to be adjusted, such as to allow more of the item to extend out of the opening 36, by loosening the thumb screws 38, adjusting the item, and tightening the thumb screws 38. Thus, the branch holder 14 can secure a tree branch or other item of various sizes and lengths. Although three thumb screws 38(1)-38(3) are illustrated in FIG. 1A -1E, in some embodiments there may be more or less than three thumb screws 38 for securing and adjusting the item in the branch holder 14. In one example, there may be two thumb screws 38 arranged equidistant around a circumference of the branch holder 14. In another example, there may be three thumb screws 38 arranged equidistant around a circumference of the branch holder 14. In some examples, there may be more than three thumb screws 38 arranged equidistant around a circumference of the branch holder 14.

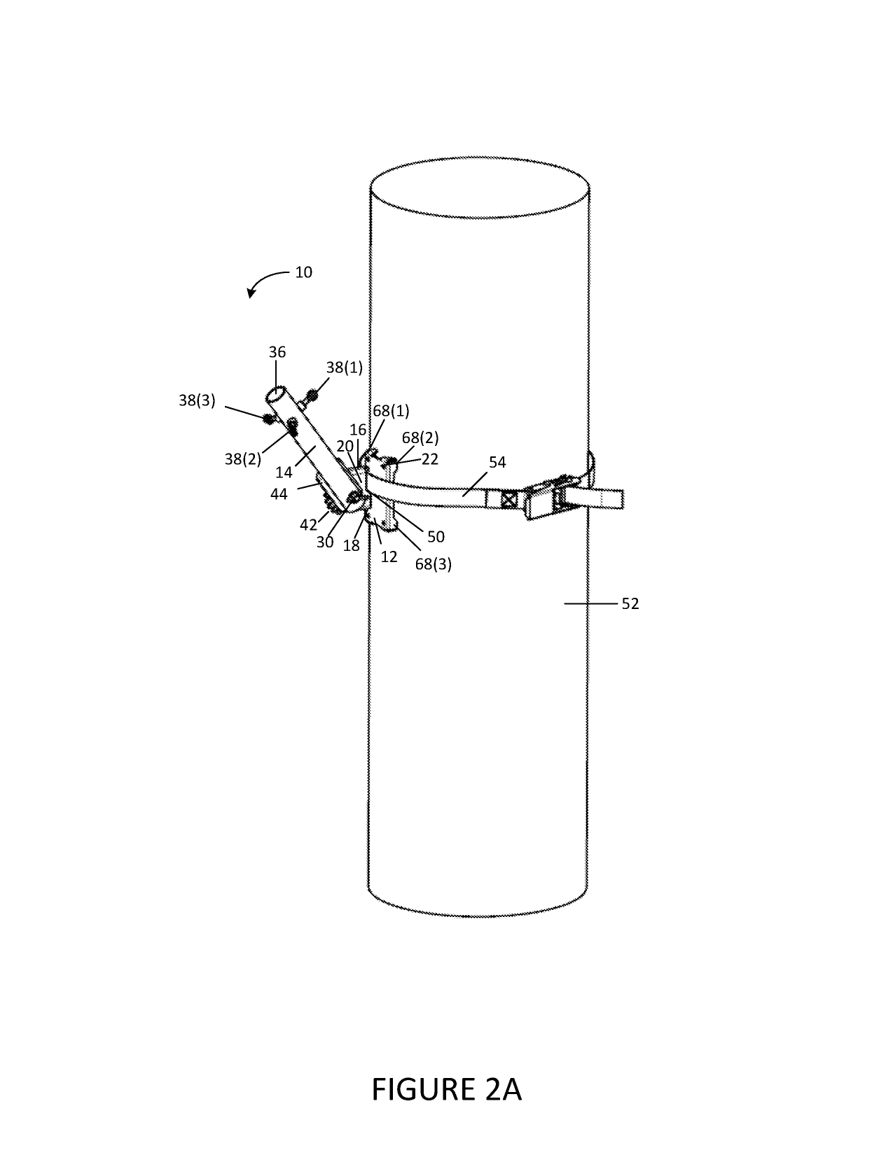

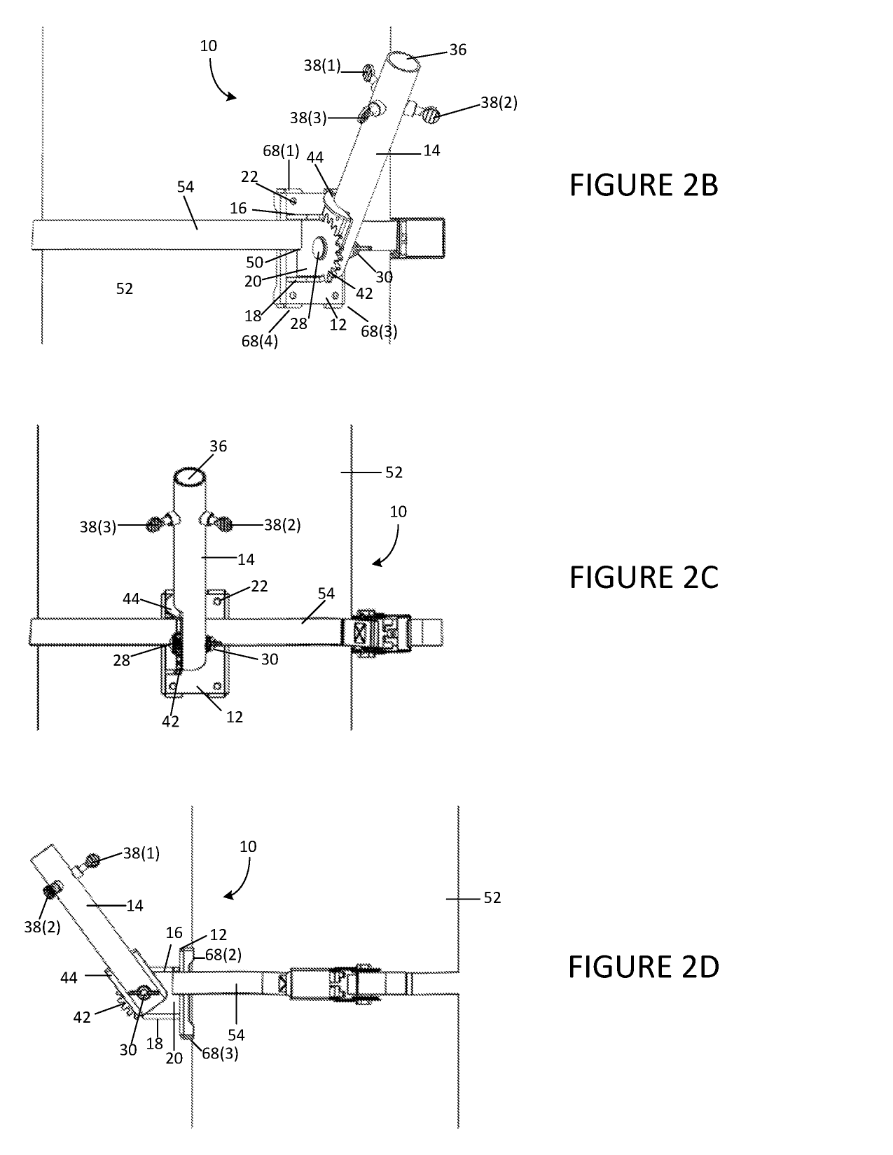

FIGS. 2A-2D illustrate various perspective views of the deer attraction apparatus 10 according to an example embodiment of the present disclosure. As illustrated in FIGS. 2A-2D, the deer attraction apparatus 10 can be secured to a structure 52, such as a post or a tree, with a strap 54. The strap 54 can be inserted over the flat top side of the base 12, through a gap 50 formed by a partial cutout in the middle tab 20, and around the structure 52 to secure the deer attraction apparatus 10 to the structure 52. For instance, the strap can be inserted over the flat face of the base 12 and under a portion of the middle tab 20 and around the structure 52. In some embodiments, the strap 54 may be a ratchet strap as illustrated, however, the strap 54 may have another mechanism for securing and adjusting the strap 54 around the structure 52, such as Velcro or hooks. In some embodiments, the strap 54 may have hooks on each end and the base 12 may have a corresponding mounting location for the hooks to be attached as a mechanism to secure the deer attraction apparatus 10 to the structure 52 by securing one end of the strap 54 to one hook on the base 12, wrapping the strap 54 around the structure 52, and securing the other end of the strap 54 to the other hook in the base 12. There may or may not be a gap 50 formed by a partial cutout in the middle tab 20 in such an embodiment with the hooked strap 54 and base 12. The strap 54 allows for affixing the deer attraction apparatus 10 to structures of varying sizes. For example, the deer attraction apparatus 10 can be placed about 4-5 feet above the ground with the base 12 against a structure 52, such as a tree, such that the branch holder 14 is facing away from the structure 52. The strap 54 can then be threaded through the gap 50 where the branch holder 14 attaches to the base 12 and secured around the structure 52 by tightening the strap 54 to secure the deer attraction apparatus 10 to the structure 52. The angle of the branch holder 14 can then be adjusted by loosening the nut 30, adjusting the branch holder 14, and retightening the nut 30. A tree limb (or a rope or dripper, as non-limiting examples) can be inserted into the opening 36 in the branch holder 14 and the thumb screws 38 can be loosened and retightened to fit the size of the tree limb and secure it in the branch holder 14.

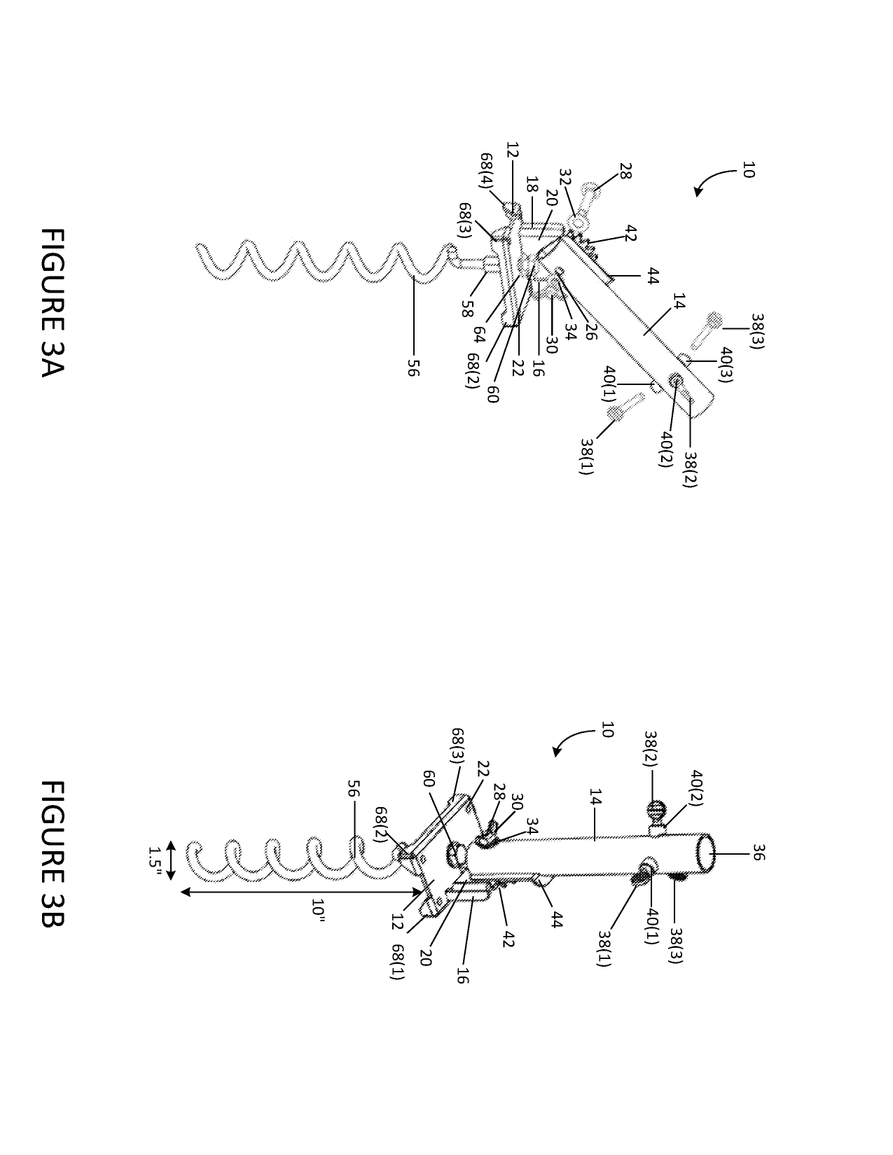

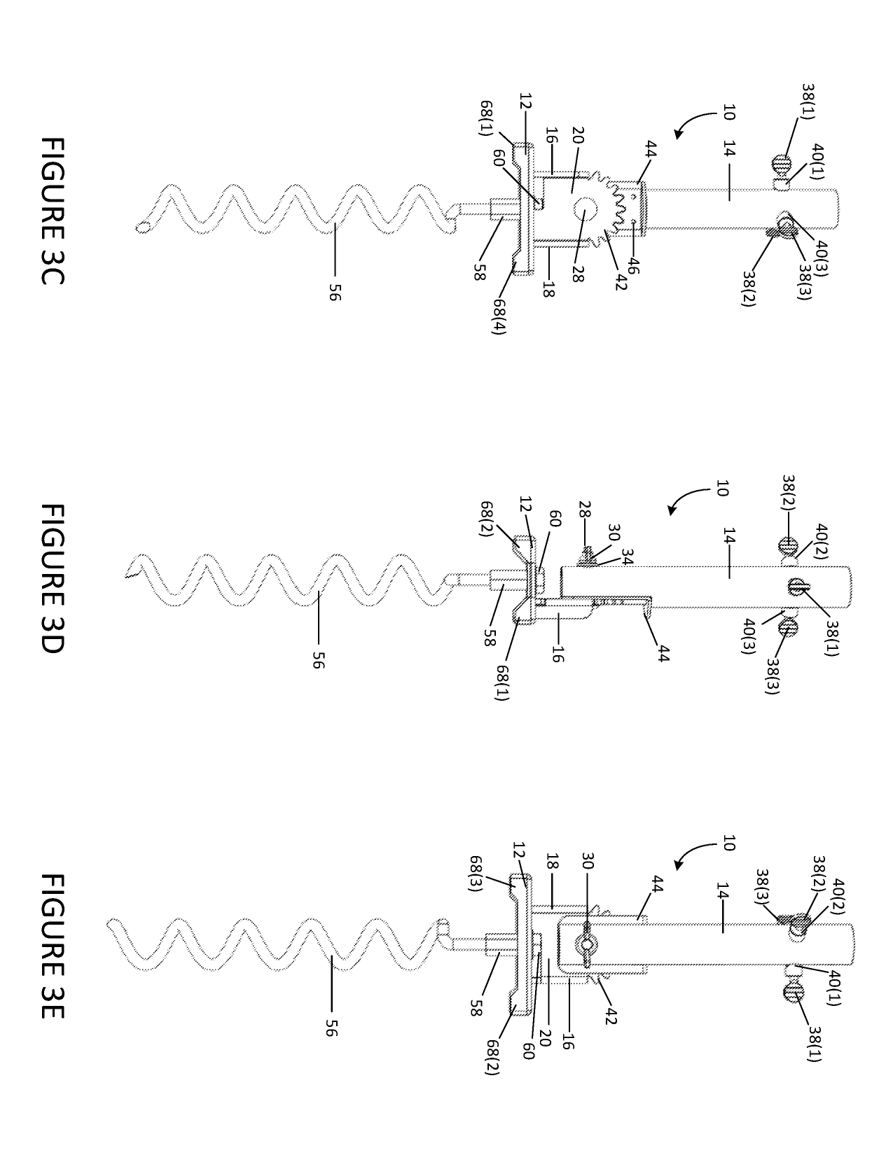

FIG. 3A is an exploded view of a deer attraction apparatus 10 according to an example embodiment of the present disclosure. FIGS. 3B-3E illustrate various perspective views of the deer attraction apparatus 10 according to an example embodiment of the present disclosure. In the examples of FIGS. 3A-3E, the deer attraction apparatus 10 is illustrated with an auger 56 attachment that can be inserted inground for securing the deer attraction apparatus 10 to the ground. An auger 56 may be a spiral attachment for inserting into the ground that is approximately one and a half inches wide and extends about ten inches from the bottom of the base 12, however longer or shorter augers may be used in some implementations. The auger 56 may include a head 58 inserted through the bottom of the base 12 and a securing device, such as a bolt 60, inserted from the top of the base 12 to affix the auger 56 to the base 12 (e.g., female threads on the head 58 secured with a bolt). The head 58 of the auger 56 may be a hex head, which allows a power tool to be attached to the head 58 and used to drive the auger 56 into the ground. In some implementations, the head 58 of the auger 56 may have threads and the securing device may be a nut for affixing the auger 56 to the base 12 (e.g., male threads on the head 58 secured with a nut). There may be a screw aperture 62 in the base 12, such as in the center of the base 12, to insert and secure the auger 56 to the base 12. In some embodiments, there may be a washer 64 inserted between the bolt 60 and the top of the base 12. The head 58 is thus captive within the base 12 which allows for the branch holder 14 to be used to manually install the auger 56 into the ground with the angle adjusted to a horizontal position. For example, the branch holder 14 can be rotated to be parallel with the base 12 by loosening the nut 30, adjusting the branch holder 14, and retightening the nut 30. The head 58 of the auger 56 attachment can then be set into the base 12 by inserting the head 58 through the bottom of the base 12 and the securing device (e.g., the bolt 60 or a nut) can be tightened (e.g., by hand or with a wrench) to secure the auger 56 to the base 12. The auger 56 can then be screwed into the ground, such as by holding the branch holder 14 and base 12 to place and secure the auger 56 in the ground.

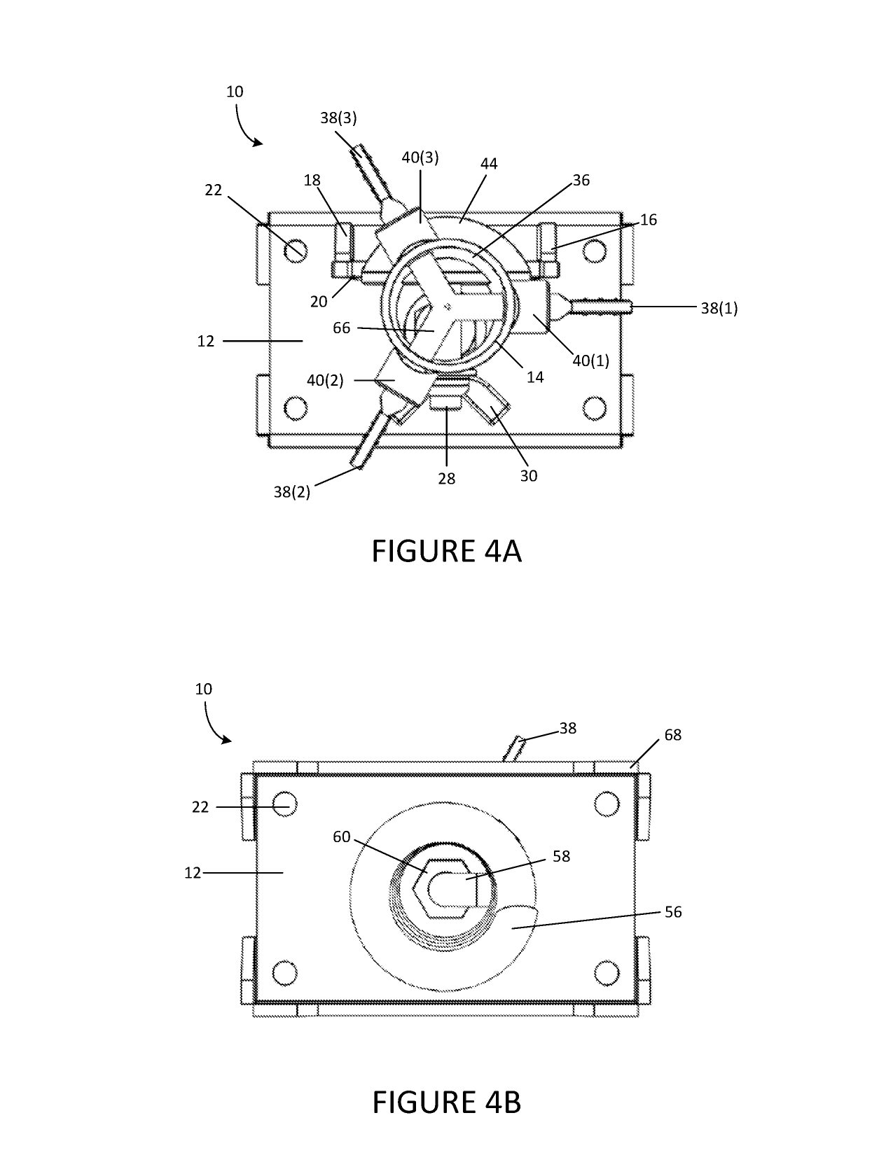

FIG. 4A is a top view and FIG. 4B is a bottom view of the deer attraction apparatus 10 according to example embodiments of the present disclosure. As illustrated in FIG. 4A, the intersection 66 of the thumb screws 38 and apertures 40 are visible through the top of the opening 36 in the branch holder 14. A tree branch or other item for attracting deer or other animals can be placed in the opening 36, through the center of the intersection 66, and the thumb screws 38 can be tightened to secure the tree branch in the branch holder 14. FIG. 4B illustrates a bottom view of the deer attraction apparatus 10 with the auger 56 attachment, while FIG. 4A illustrates the deer attraction apparatus 10 without any of the attachments affixed to the deer attraction apparatus 10 for securing it to a structure or the ground.

The presently disclosed systems and methods have a wide application anywhere in the hunting industry where attracting deer is needed. One particularly important application for the apparatus described herein relates to attracting deer with a branch to lick which will attract other deer to the area. Additional applications for the apparatus include attracting deer with other baits that can be placed in the apparatus to attract deer to the area. However, the apparatus described above could be utilized in other contexts.

Those skilled in the art will recognize improvements and modifications to the preferred embodiments of the present disclosure. All such improvements and modifications are considered within the scope of the concepts disclosed herein and the claims that follow.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

Furthermore, the described features, structures, or characteristics of the disclosure may be combined in any suitable manner in one or more embodiments. In the description contained herein, numerous specific details are provided to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

What is claimed is:

1. A deer attraction apparatus, comprising:
a base having a rectangular shape with a flat face comprising a support structure comprising a top tab extending outward from the base, a bottom tab extending outward from the base, and a middle tab between the top tab and the bottom tab, the middle tab comprising a screw aperture and a partial cutout, wherein a gap is formed between the base and the partial cutout; and
a branch holder extending radially outward from the base and affixed to the middle tab, a screw inserted through the screw aperture and through a screw aperture of the branch holder and secured with a nut to adjust an angle of the branch holder, the branch holder comprising an opening at an end opposite from the base and at least one screw inserted at least partially in the branch holder for adjusting and securing an item at least partially inside the branch holder.

2. The deer attraction apparatus of claim 1, wherein the gap formed between the base and the partial cutout of the middle tab is configured for a strap inserted over the base and under a portion of the middle tab and around a structure.

3. The deer attraction apparatus of claim 2, further comprising a ratchet strap adjustable to a size of the structure.

4. The deer attraction apparatus of claim 1, wherein the base is supported by a plurality of feet, each foot extending from each corner of the bottom of the base to rest against a structure.

5. The deer attraction apparatus of claim 1, wherein the base comprises a plurality of screw apertures and the base is screwed into a structure with a screw inserted in each of the plurality of screw apertures.

6. The deer attraction apparatus of claim 1, wherein the base comprises a mounting bracket with the top tab and the bottom tab extending from a flat portion of the mounting bracket.

7. The deer attraction apparatus of claim 1, wherein the branch holder is configured to adjust and secure the item inside the branch holder with the at least one screw.

8. The deer attraction apparatus of claim 1, wherein the at least one screw comprises three screws arranged equidistant around a circumference of the branch holder.

9. The deer attraction apparatus of claim 1, wherein the item comprises a dripper affixed to the item.

10. The deer attraction apparatus of claim 1, wherein the middle tab further comprises a plurality of teeth facing away from the base.

11. The deer attraction apparatus of claim 1, wherein the middle tab further comprises a semi-circle holder wrapped around a portion of the bottom of the branch holder and affixed between the middle tab and the branch holder.

12. A deer attraction apparatus, comprising:
a base having a rectangular shape with a flat face comprising a centrally located screw aperture through the flat face and a support structure comprising a top tab extending outward from the base, a bottom tab extending outward from the base, and a middle tab between the top tab and the bottom tab, the middle tab comprising a screw aperture; and
a branch holder extending radially outward from the base and affixed to the middle tab, a screw inserted through the screw aperture and through the branch holder and secured with a nut to adjust an angle of the branch holder, the branch holder comprising an opening at an end opposite from the base and at least one screw inserted in the branch holder for adjusting and securing an item at least partially inside the branch holder.

13. The deer apparatus of claim 12, further comprising an auger comprising a head inserted through the centrally located screw aperture of the base and a securing device to affix the auger to the base.

14. The deer apparatus of claim 13, wherein the head of the auger comprises threads and the securing device comprises a nut.

15. The deer apparatus of claim 13, wherein the securing device comprises a bolt.

16. The deer attraction apparatus of claim 13, wherein the head of the auger comprises a hex head configured to secure a power tool for inserting the auger inground.

17. The deer attraction apparatus of claim 13, wherein the auger is inserted inground for securing the deer attraction apparatus to the ground.

18. The deer attraction apparatus of claim 13, wherein the branch holder is configured to adjust and secure the item inside the branch holder with the at least one screw.

19. The deer attraction apparatus of claim 12, wherein the base comprises a plurality of screw apertures and the base is screwed into a structure with a screw inserted in each of the plurality of screw apertures.

20. A deer attraction apparatus, comprising:
a base having a rectangular shape with a flat face comprising a support structure comprising a top tab extending outward from the base, a bottom tab extending outward from the base, and a middle tab between the top tab and the bottom tab, the middle tab comprising a screw aperture and a partial cutout, wherein a gap is formed between the base and the partial cutout, the gap configured for an adjustable strap inserted over the flat face of the base and under a portion of the middle tab and around a structure for securing the deer attraction apparatus to the structure; and
a branch holder extending radially outward from the base and affixed to the middle tab with a screw inserted through the screw aperture and through the branch holder and secured with a nut to adjust an angle of the branch holder, the branch holder comprising an opening at an end opposite from the base and at least one screw inserted in the branch holder for adjusting and securing a tree branch at least partially inside the branch holder.
